(19) United States
(12) Patent Application Publication
(10) Pub. No.: US 2006/0136284 A1
(43) Pub. Date: Jun. 22, 2006

(54) Recommendation system

(76) Inventors: Baruch Awerbuch, Washington, DC (US); Boaz Patt-shamir, Tel Aviv (IL); David Peleg, Rehovot (IL); Mark Rogers Tuttle, Arlington, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/015,276

(22) Filed: Dec. 17, 2004

(51) Int. Cl. G07G 1/00

(52) U.S. Cl. 705/10

(57) ABSTRACT

A technique for recommending products to a user (110a). According to the technique, the user requests (110a) a recommendation from a recommendation system (200). The recommendation system (200) generates a recommendation using a technique whose time complexity is less than O(m·n). The generated list is then presented to the user (110a).

### BACKGROUND OF THE INVENTION

The present invention is related to data systems and more particularly to recommendation systems utilized in data systems.

As more and more consumers have turned to the Internet to shop for goods, retailers have incorporated electronic commerce (e-commerce) systems into their marketing strategies to reach this vast market of potential consumers. In addition, e-commerce has given rise to a new form of marketing wherein sales transactions with consumers are almost exclusively handled electronically through the Internet. Many retail e-commerce systems incorporate recommendation systems to provide product recommendations to buyers or potential buyers.

A recommendation system is a system that recommends items to a user based on e.g., the user's observed behavior or the behavior of other users. This behavior may include past transactions of the user (e.g., the user's shopping behavior, documents viewed by the user, web pages visited by the user), a request from the user to provide recommendations, or the past transactions or requests of other uses. Recommendation systems may be deployed in a variety of environments including e-commerce, corporate intranets to e.g., provide help in finding expertise within a corporation, medical applications where e.g., patients are matched to doctors, and customer relationship management (CRM) systems where e.g., customer problems may be matched to certain experts within a support organization.

Many techniques are available that may be implemented in a recommendation system to produce recommendations for users. One such technique is described in P. Drineas, et al., “Competitive Recommendation Systems,” Proceedings 34^{th} Association for Computing Machinery (ACM) Symposium on Theory of Computing (STOC), 2002, pp. 82-90. This technique employs a centralized solution for providing recommendations that is based on matrix reconstruction. The technique assumes that a user has a preference among all products presented to the user and that the preference may be represented by a real-valued number. Further, the technique assumes that most users have preferences which are close to one of a few dominant but unknown types. The technique chooses a committee of users, asks them to try various sets of product, uses their responses to classify the users according to type and uses the types to recommend products to the users. The technique maintains a preference matrix which represents the preferences of all the users.

One problem with the above-described technique is that user classification is based on powerful algebraic methods that are used to approximate the preference matrix. These methods are on the order of O(m·n) time complexity, wherein “O” is conventional big-O notation for “on the order of,” “m” is a number of users and “n” is a number of products. In systems where there are many users and many products, this technique may not be practical due to the high time complexity and computing power needed to provide recommendations.

### SUMMARY OF THE INVENTION

The present invention overcomes shortcomings associated with the prior art by incorporating a technique for recommending products to a computer user that is less than O(m·n) in time complexity. According to the inventive technique, the computer user requests a recommendation for a product from a recommendation system. A recommended product is determined by the recommendation system using a technique whose time complexity is less than O(m·n). The recommended product is then presented to the computer user.

Illustratively, one of two techniques is used to determine the recommended product. A first technique involves (a) forming a committee of recommenders from a set of all recommenders, (b) having each recommender in the committee probe (test) all products in a set of products to identify a product to recommend and (c) generating the list of recommended products from products recommended by the recommenders in the committee. A second technique involves (a) “flipping a coin,” (b) if the results are “heads,” selecting a product at random to recommend, if the results are “tails,” choosing a recommender at random and recommending the product recommended by the chosen recommender.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level schematic block diagram of a data network that may be used with the present invention.

FIG. 2 is a high-level partial schematic block diagram of a computer system that may be used with the present invention.

FIG. 3 is a flow diagram of a sequence of steps that may be used to determine a recommended product in accordance with the present invention using a centralized technique.

FIG. 4 is an exemplary illustration of determining a recommendation for a user in accordance with the present invention using a centralized technique.

FIG. 5 is a flow diagram of a sequence of steps that may be used to determine a recommended product in accordance with the present invention using a distributed technique.

FIG. 6 is an exemplary illustration of determining a recommendation for a user in accordance with the present invention using a distributed technique.

FIG. 7 is a flow diagram of a sequence of steps that may be used to generate a recommendation for a computer user in accordance with the present invention.

### DETAILED DESCRIPTION OF THE INVENTION

A description of preferred embodiments of the invention follows.

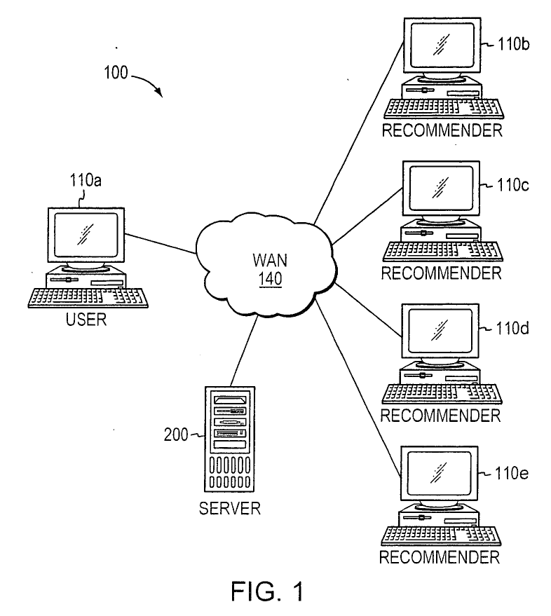

FIG. 1 is a high-level schematic block diagram of an exemplary data network 100 that may be used with the present invention. Data network 100 comprises a network of nodes 10a-e, 200 coupled together via a wide-area network (WAN) 140, such as the Internet, to form an internetwork of nodes. Illustratively, these nodes may be conventional personal computers (PCs), such as nodes 100a-e, or server nodes, such as node 200. The nodes exchange information over the data network using various protocols, such as the Transmission Control Protocol/Internet Protocol (TCP/IP).

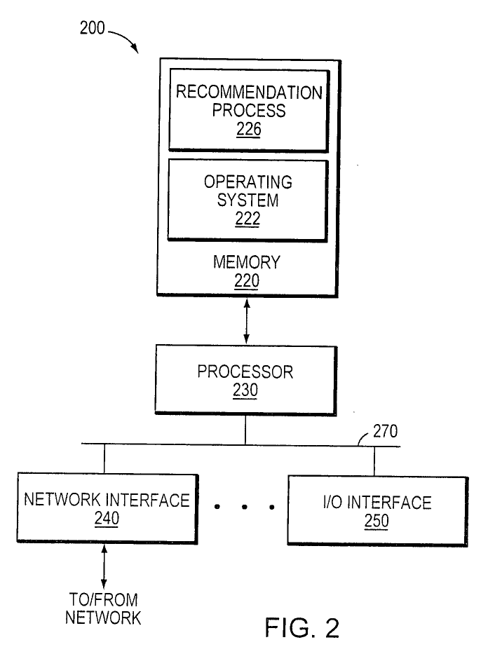

FIG. 2 is a high-level partial schematic block diagram of a node 200 that may be used with the present invention. Node 200 comprises a memory 220 coupled to a processor 230 which is coupled via an input/output (I/O) bus 270 to a network interface 240 and one or more I/O interfaces 250.

Processor 230 is illustratively a conventional processor that contains logic for executing instructions and manipulating data contained in memory 220. In addition, processor 230 contains logic that enables it to transfer data between the network interface 240 for transfer to and from the network 100. Network interface 240 contains logic configured to interface node 200 with the network 100 and enable data to be transferred between node 200 and the data network 100. I/O interfaces 250 contain logic configured to interface various I/O devices (not shown), such as storage devices (e.g., disk storage unit), output devices (e.g., display unit, printer) and input devices (e.g., keyboard, mouse), with the processor 230 to enable the processor 230 to transfer data between the processor 230 and the I/O devices.

The memory 220 is a computer-readable medium organized as a random-access memory (RAM) and implemented using various RAM devices, such as dynamic-random-access memory (DRAM) devices. The memory is configured to hold various computer executable instructions and data structures including computer executable instructions and data structures that implement aspects of the present invention. It should be noted that other computer readable mediums, such as disk units and flash memory, may be configured to hold computer readable instructions and data that implement aspects of the present invention. In addition, it should be noted that various electromagnetic signals may be encoded to carry instructions and data that implement aspects of the present invention.

Memory 220 contains an operating system 222 and a recommendation process 226. The operating system 222 is a conventional operating system that enables processes, such as process 226, to, inter alia, be scheduled for execution and to access various devices on node 200, such as network interface 240. The recommendation process 226 contains computer executable instructions and data structures that, as will be described further below, implement a recommendation system in accordance with the present invention.

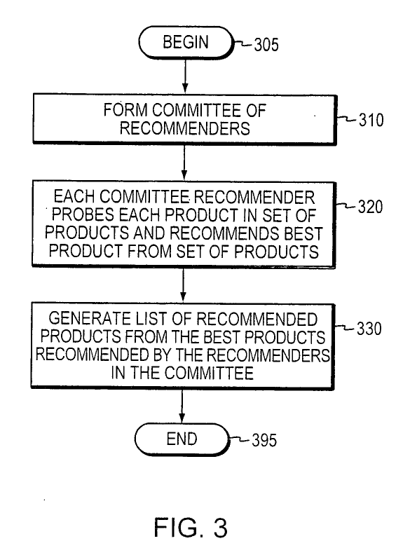

FIG. 3 is a flow chart of a sequence of steps that may be used to generate a recommended list of products in accordance with the present invention using a centralized technique. The sequence begins at step 305 and proceeds to step 310 where a committee of recommenders is formed. The committee comprises a subset of recommenders selected from a set of recommenders that has a cardinal value that is greater than zero but less than the cardinal value for the set of recommenders. Illustratively, the committee members are selected uniformly at random where the number of committee members selected is “κ ln(κ/ε)” wherein “κ” is an integer that is greater than or equal to zero and represents a number of preference types, and “γ” is a value that is greater than zero but less than or equal to 1 and represents an error value which, illustratively, represents a probability of failing to generate a good recommendation.

The number of preference types is a value that measures how similar the recommenders are with respect to the way they rate products. Each time a recommender tests a product, it assigns a rating to the product. The rating may be, for example, “good” or “not good”, an integer between 1 and N or a real value between 0 and 1. Each recommender is described by a type that determines, for each product, what rating the user will assign to the product upon testing it. The value of K is the number of distinct types needed to describe the recommenders. For example, suppose the possible ratings are “good” and “not good” indicating whether a product is good or not, there are three recommenders R1, R2, and R3 and two products P1 and P2. If R1 and R2 like P1 and R3 likes P2, then the number of preference types is 2, that is, the type vector (good, not good) describes R1's and R2's preferences of the products, and the type vector (not good, good) describes R3's preferences of the products.

At step 320, each recommender in the committee probes each product in the set of products to identify a best product from the set of products. At step 330, a list is generated that contains the best products identified by each recommender. The sequence ends at step 395.

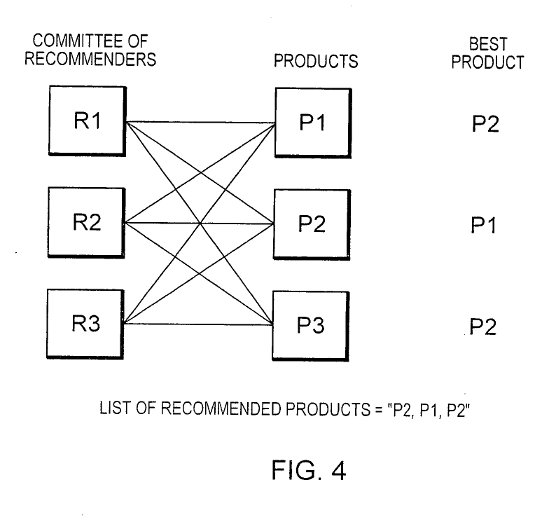

FIG. 4 is an exemplary illustration of generating a recommendation for a user in accordance with the present invention using the above-described centralized technique. Assume the committee comprises three recommenders R1, R2 and R3 and that a set of products reviewed by the committee comprises three products P1, P2 and P3. According to the technique, each recommender probes (tests) each product (as indicated by lines extending from each recommender “R” to each product “P”). The best product identified by each recommender is listed in the column labeled “Best Product.” Thus, R1 has identified P2 to be its best product, and R2 and R3 have identified P1 and P2, respectively, to be their best products. The list of recommended products, i.e., “P2, P1, P2” is generated by combining the best products found by each recommender in the committee recommenders. This list may be further reduced to “P1, P2” by eliminating duplicate product recommendations. Note that although each committee member probes each product, since the number of committee members chosen is less than the number of recommenders (i.e., “m”), the time complexity of the above-described technique is less than O(m·n) wherein “0” is conventional big-O notation meaning “on the order of” “m” is a number of recommenders in the set of recommenders and “n” is a number of products in the set of products.

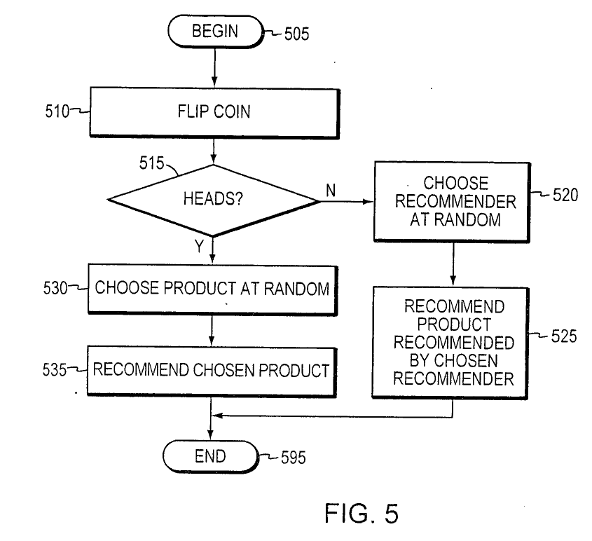

In accordance with the present invention, a product recommendation may be determined using a distributed technique. According to this technique, a product recommendation is made by (a) randomly choosing a product and recommending the chosen product or (b) randomly choosing a recommender and recommending a product that is recommended by the chosen recommender. FIG. 5 is a flow diagram of a sequence of steps that may be used to recommend a product in accordance with the present invention using a distributed technique.

The sequence begins at step 505 and proceeds to step 510 where a coin is tossed (flipped), wherein one side of the coin is “heads” and another side is “tails,” to choose a result of either heads or tails. Illustratively, a selection is made between a heads and a tails result such that a result of heads has an equal probability of occurring as a result of tails. At step 515, a check is performed to determine if the result of the coin toss is heads. If not, (i.e., the result of the coin toss is tails), the sequence proceeds to step 520, where a recommender from a set of recommenders is chosen, and step 525, where a product recommended by the chosen recommender is recommended. Illustratively, the recommender is chosen in a uniformly random manner and the product recommended is the best product the recommender has found from the set of products at this time.

If, at step 515, the result of the coin toss is heads, the sequence proceeds to step 530, where a product from a set of products is chosen, and step 535, where the chosen product is recommended. Illustratively, the product is chosen in a uniformly random manner. The sequence ends at step 595.

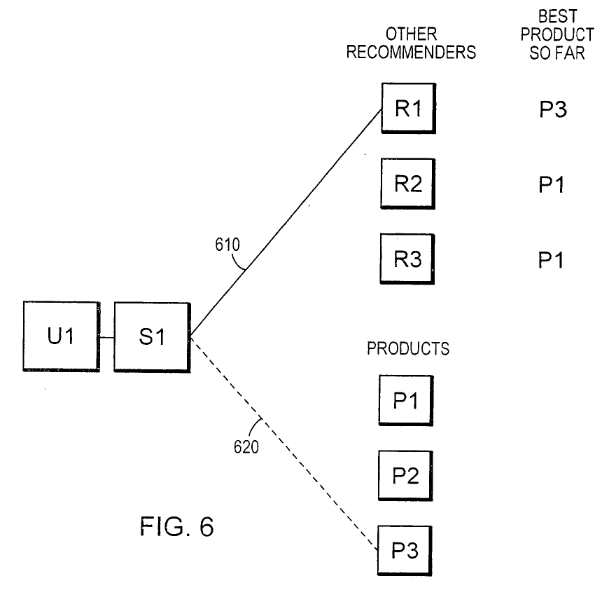

FIG. 6 is an exemplary illustration of determining a recommendation for a user in accordance with the present invention using the above-described distributed technique. Assume the set of products comprises P1, P2 and P3, and the set of recommenders comprises R1, R2 and R3. Further, assume a server S1 wishes to determine a product to recommend to user U1 in accordance with above-described technique.

Referring to FIGS. 5 and 6, at step 510, S1 figuratively “flips a coin” to determine if a product is recommended from the set of products or from a recommendation provided by a recommender. Assume the result of the coin toss is tails. At step 515, the sequence proceeds to step 520 where S1 chooses a recommender illustratively at random from the set of recommenders. As illustrated by line 610, assume recommender R1 is chosen and that the best product found by R1 is P3. At step 525, S1 recommends product P3 to user U1 based on R1's recommendation.

Now, assume at step 515 that the result of the coin toss is tails. The sequence proceeds to step 525 where S1 chooses a product illustratively at random from the set of products and recommends the chosen product (step 535). Assume S1 chooses product P3 as represented by line 620. At step 535, S1 recommends product P3 to U1.

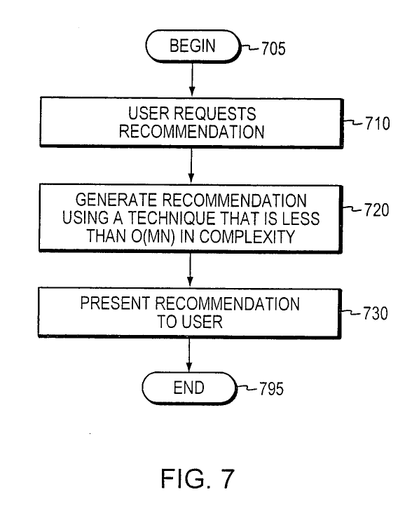

FIG. 7 is a flow chart of a sequence of steps that may be used to make a product recommendation to a user in accordance with the present invention. The sequence begins at step 705 and proceeds to step 710 where a user requests a recommendation illustratively from a recommendation system. At step 720, the recommendation system determines a recommendation using a technique that is less than O(m·n) in time complexity. At step 730, the recommendation system presents the recommendation to the user. Illustratively, the recommendation is presented to the user via a user interface (e.g., a web interface) for display on a screen viewable by the user. The sequence ends at step 795.

For example, referring to FIGS. 1 and 7, assume user 200a requests a recommendation from server 200. Further assume that server 200 determines a recommendation using the above-described centralized technique for a product in a set of products that comprises P1, P2 and P3. At step 710, the user 200a issues a request (e.g., a message) to server 200 for a recommendation. At step 720, server 200 determines a recommendation using the above-described centralized technique.

Specifically, referring to FIG. 3, at step 310, server 200 forms a committee of recommenders, as described above. Assume server 200 chooses recommenders 200b-d to participate in the committee. At step 320, each member of the committee probes each product in the set of products and recommends the best product it has found. Assume, recommenders 200b and 200d recommend product P2 and recommender 200c recommends product P1. At step 330, server 200 generates a list of products from the products recommended by the committee. Thus, illustratively, the list comprises products P1 and P2.

Returning to FIG. 7, at step 730, server 200 presents the recommendation to the user 110a. Illustratively, the recommendation is presented as a single recommendation chosen from the list. Here, the server 200 stores the list, and each time the user returns to the system for a new recommendation, the system presents a new recommendation from the list until the list is exhausted. Alternatively, the content of the entire list may be presented to the user as a recommendation.

Now assume as above except that server 200 determines a recommendation using the above-described distributed technique. At step 720, server 200 illustratively determines a product to recommend using the distributed technique described in FIG. 5. Specifically, referring to FIG. 5, at step 510, server 200 figuratively flips a coin to randomly choose between a heads and a tails result. Illustratively, server 200 randomly chooses between a heads and a tails result such that a result of heads has an equal probability of occurring as a result of tails. Here, heads and tails may be internally represented in server 200 as values, such as Boolean values (e.g., TRUE, FALSE) or numerical values (e.g., 0 and 1) and a random number generator configured to produce either a heads or tails result in a uniformly random manner may be used to randomly choose between the values. Assume the result of the coin toss is heads. At step 515, server 200 proceeds to step 525 where it selects a product at random. Assume product P1 is selected. At step 540, server 200 determines that the recommended product is the selected product and at step 730 presents the recommended product to the user 110a.

Now assume the result of the coin toss is tails. At step 515, server 200 proceeds to step 520 where it chooses a recommender, illustratively at random, and selects a product recommended by the recommender. Assume server 200 chooses recommender 110b. Illustratively, server 200 sends a message to recommender 110b to request its product recommendation. Assume recommender 10b recommends product P3. Recommender 110b illustratively responds by sending a message to server 200 containing the recommended product (i.e., P3). At step 730 (FIG. 7), server 200 presents the recommended product to the user 110a.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for providing a recommendation of a product to a computer user, the method comprising the steps of:
generating a recommendation of a product from a set of products using a technique that is less than O(m·n) in computational complexity with respect to time, wherein O is conventional big-O notation for on the order of, m is a number of recommenders in a set of recommenders that provide recommendations for products in the set of products and n is a number of products in the set of products; and
presenting the recommendation to the computer user.

2. A method as defined in claim 1 further comprising the steps of:
selecting a committee of recommenders from the set of recommenders;
for each recommender in the committee, probing each product in the set of products to identify a recommended product; and
generating a list of recommended products from the products recommended by each recommender in the committee.

3. A method as defined in claim 2 wherein the number of recommenders selected for the committee of recommenders is determined as κ ln(κ/γ) wherein “κ” is an integer that is greater than or equal to zero and represents a number of preference types, “ln” is the natural logarithm function and “γ” is a value that is greater than zero but less than or equal to 1 and represents an error value.

4. A method as defined in claim 2 further comprising the step of:
recommending a product from the list of products.

5. A method as defined in claim 1 wherein the technique is a distributed technique.

6. A method as defined in claim 1 further comprising the steps of:
choosing a product from the set of products; and
recommending the chosen product.

7. A method as defined in claim 6 wherein the product is chosen at random.

8. A method as defined in claim 1 further comprising the steps of:
choosing a recommender from the set of recommenders; and
recommending a product that is recommended by the chosen recommender.

9. A method a defined in claim 8 wherein the recommender is chosen at random.

10. A node for providing a recommendation to a computer user, the node comprising:
a memory containing a recommendation process; and
a processor configured to execute the recommendation process, wherein the recommendation process is configured to cause the processor to:
(a) generate a recommendation of a product from a set of products using a technique that is less than O(m·n) in computational complexity with respect to time, wherein O is conventional big-O notation for on the order of, m is a number of recommenders in a set of recommenders that provide recommendations for products in the set of products and n is a number of products in the set of products, and
(b) present the recommendation of a product to the computer user.

11. A node as defined in claim 10 wherein the recommendation process is further configured to cause the processor to:
(a) select a committee of recommenders from the set of recommenders, and
(b) generate a list of recommended products from products recommended by each recommender in the committee.

12. A node as defined in claim 11 wherein the recommendation process is further configured to cause the processor to present the generated list of recommended products to the computer user.

13. A node as defined in claim 10 wherein the recommendation process is further configured to cause the processor to:
(a) choosing a product from the set of products, and
(b) recommend the chosen product.

14. A node as defined in claim 10 wherein the recommendation process is further configured to cause the processor to:
choose a recommender from the set of recommenders, and recommend a product that is recommended by the chosen recommender.

15. A node as defined in claim 10 wherein the technique is a distributed technique.

16. An apparatus for providing a recommendation to a computer user, the apparatus comprising:
means for generating a recommendation of a product from a set of products using a technique that is less than O(m n) in computational complexity with respect to time, wherein O is conventional big-O notation for on the order of, m is a number of recommenders in a set of recommenders that provide recommendations for products in the set of products and n is a number of products in the set of products; and
means for presenting the recommendation to the computer user.

17. An apparatus as defined in claim 16 further comprising:
means for selecting a committee of recommenders from the set of recommenders; and
means for generating a list of recommended products from products recommended by each recommender in the committee.

18. An apparatus as defined in claim 16 comprising:
means for choosing a product from the set of products; and
means for recommending the chosen product.

19. An apparatus as defined in claim 16 comprising:
means for choosing a recommender from the set of recommenders; and
means for recommending a product that is recommended by the chosen recommender.

20. A computer readable medium comprising computer executable instructions for:
generating a recommendation of a product from a set of products using a technique that is less than O(m·n) in computational complexity with respect to time, wherein O is conventional big-O notation for on the order of, m is a number of recommenders in a set of recommenders that provide recommendations for products in the set of products and n is a number of products in the set of products; and
presenting the recommendation to a computer user.
